(19) United States
(12) Patent Application Publication
(10) Pub. No.: US 2014/0315297 A1
(43) Pub. Date: Oct. 23, 2014

(54) METHOD FOR ISOLATING CELLS AND BIOPARTICLES

(71) Applicant: PLURISELECT GMBH, Leipzig (DE)

(72) Inventors: Jan-Michael Heinrich, Leipzig (DE); Christoph Mohr, Leipzig (DE)

(21) Appl. No.: 14/355,108

(22) PCT Filed: Nov. 14, 2012
(86) PCT No.: PCT/DE2012/001106

§ 371 Date: Apr. 29, 2014

(30) Foreign Application Priority Data
Nov. 14, 2011 (DE) 10 2011 118 386.1

(51) Int. Cl. G01N 1/34

(52) U.S. Cl. CPC G01N 1/34
USPC 435/325

(57) ABSTRACT

The invention relates to a simple and inexpensive method for simultaneous isolation of cells and/or bioparticles from complex fluids that differ in one or more surface properties (e.g. cell sub-populations). For that purpose, the surface of a solid carrier is modified in a manner to be provided with different capture molecules, which allows in an additional step a specifically “neutralizing” of individual target particles. Different target particles with both identical and different recognition structures are to be gradually detached from the capture particles and isolated/separated. Areas of application of the invention are biotechnology (including biological and medical research), diagnosis and treatment of diseases.

The invention describes a method for the simultaneously isolation of cells and/or bioparticles from complex fluids, that differ in one or more surface properties. With their different surface marker cells and/or bioparticles can be specific recognized and separated step by step using suitable carrier and immobilization methods known per se.

The invention describes a simple method for the gentle separation/isolation of cells and/or particles from fluids, preferably blood. These use known steps of protein-coupling methods, protein cleavage methods, hydrolysis of intermolecular and intra-molecular hydrogen bonds, protein displacement methods and antigen-antibody separation methods combined with the method of a particle-catcher sieve separator.

Cells are understood as: Any somatic cell type, whether in the physiological or pathological state regulation; microorganisms such as bacteria, yeast/fungi and protozoa, and viruses. Bioparticles are understood to mean any condition of organic molecules, which is accompanied by the loss of solubility in a liquid medium (e.g. blood, culture media, cell culture media, cell preparations in buffers etc.). For simplicity, the terms target cells and bioparticles are summarized under the term “target particles” below.

Areas of application of the invention are biotechnology (including biological and medical research), diagnostics and treatment of diseases.

### STATE OF THE ART

The process of identifying, separating and isolating target particles, in particular of somatic cells and pathogens from complex fluids such as blood is a necessary procedural step for the research, diagnosis and treatment of disease.

For the separation of target particles with different specific density (e.g. leukocytes and erythrocytes) centrifugation or filtration methods has been successful proved. With the advances in the study of pathogenesis and immunogenesis of diseases, there is a growing need for identification, separation and isolation of cells with the same specific density but different function. The different function of lymphocytes is displayed on the outer cell membrane accompanied by the expression of typical structures (such as the so-called clusters of differentiation—CDs). Against these structures antibodies can be generated that are the ultimate tool for the more specific separation processes. Fluorescence-activated separation methods and magnetic activated separation methods have been proven for decades for this task. Recently, the company pluriSelect (Germany) provided also a catcher particle-based sieve separation process (DE 10 2007 041 049.4). These methods allow in a simple way to isolate cells from complex fluids, which are different in their feature on the membrane from the other.

Many cells have different functions, but often carry a similar (overlapping) surface marker in addition to differing characteristics, such as NK-cells (CD8+, CD56+, CD162R), cytotoxic T-cells (CD8+, CD3+) T-helper cells (CD3+, CD4+), regulatory T-cells (CD3+, CD25+, CD4+).

The isolation of cells, which has only one desired combination of CD factors, is still a major challenge in biological research. Currently, this task can only be solved by Fluorescence Activated Cell Sorting (FACS) with fluorescent labeling of multiple markers. FACS is undoubtedly the gold standard for the diagnostic separation of cells but associated with a high cost of apparatus and staff time. Other disadvantages of this technology are the high stress for the isolated cells and it also requires complicated sterile working conditions. Furthermore, the sorting of a large number of viable cells are placed in the methodological limitations.

FACS application causes problems for the isolation of large numbers of cells. The medium containing the cells must be highly diluted, the separation time for larger quantities of cells is relatively long and it causes problems to observe aseptic conditions. The implementation of the method caused a significant overall cost and is not for therapeutic (GMP compliant) inserts appropriate.

Another invention for the separation/isolation of cells with the same and different surface structures is described in DE 10 2009 037 331.4. The invention solves this problem by a novel combination of magnetic and particle trap-assisted sieve separation process. However, in this invention, different carriers are used simultaneously.

### Task/Goal

The aim of the invention is to develop a simple method for the separation of target particles from complex mixtures of cells, which enables separation of the cells and/or bioparticles that differ in one or more surface properties, with fewer steps and lower cost. It should also be suitable for the use in complex fluids such as blood or serum.

The invention is realized defined in claims 1-13.

### DESCRIPTION OF THE INVENTION

The task of the invention is solved by developing a process in which the surface of a solid carrier will be modified in a manner to be provided with different capture molecules, which allows through additional processing steps to “neutralize” specifically individual target particles. Thereby different target particles with the same as well as different detection structures are gradually detached from the capture particles and are isolated/separated.

As neutralization of the capture molecule, any neutralization treatment is understood which causes a disintegration of the bridges between particles and the target capture sequence, for example by is peeling/cutting from the capture particles, or by disintegration of the antibody-antigen binding site. In this result the binding site has now no physical contact between capture particles and target particles any more. The different strategies can be combined depending on the goal.

The invention relates in particular to a method for the separation and isolation of different cells or bioparticles by means of a solid carrier, characterized in that the solid carrier on the surface harbors at least two capture molecules of different target specificity coupled by known methods and from the at least one capture molecule, can be treated by known methods so that the direct bridge connection between the capture molecule and the target particles, or between the capture molecule and the carrier is dissolved with a liquid containing the target particles is brought into contact, and then first the carrier capture molecule-target complexes isolated only by means of known process and then the target particles are removed sequentially via cleavage of the respective bridge connection.

In this case it is particularly suitable if as capture molecules antibodies are used that are attached to the surface bound by adsorption in non-covalently or covalently way.

Particularly of advantageous is, when the capture molecules are provided directly or via a spacer/bridge molecules with predetermined properties for a chemical or enzymatic or physical separation between the spacer and the target and if the capture molecules preferably are made additionally magnetizable and/or fluorescent.

It is advantageous to use a method in which the bridge connection between the carrier-capture molecule complex and the target particles is resolved by a separation of the capture molecule from the target particles or from the vehicle or by resolution of the binding between the capture molecule and target particles.

Particularly suitable is a method in which the separation of the capture molecule from the target particles or the solid carrier takes place by the action of enzymes or hydrogen bond reducing substances.

In particular, the resolution of the binding between the capture molecule and target particles by a displacement reaction by receptor- or acceptor-mimicking substances with higher specific strength than the bond between the capture molecule receptor and target particles acceptor has been proven itself.

Preferably a different procedure for the resolution of the direct bridge connection between the carrier-capture molecule complex and target particles is provided, this is done for each desired specificity of capture molecule on the solid carrier.

In an advantageous embodiment many different capture molecule specificities on the surface of a solid support are unlimited bound, limited only by steric hindrance by the number of target particles and the sum of the available procedures for resolution of the direct bridge connection between the carrier-capture molecule-complex and target particles.

In a further advantageous embodiment, the dissolution of the bridge connection between solid carrier-capture molecule complex and target particles complex, for example, reducing agents such as β-mercaptoethanol, dithiothreitol, dithioerythritol, tris (hydroxypropyl), tris(2-carboxyethyl) phosphine, enzymes depending to the existing interface within or in the proximity of the spacer and substances with higher avidity than the existing between the capture molecule receptor and Target particle receptor such as displacing Destiobiotin by biotin are used.

A further embodiment of the invention, uses solid carrier to isolate target particles with both matching and different capture molecule-target specificities by gradual dissolution of the bridge connection between the carrier-capture molecule complex and target particles and followed by a subsequent separation by means of known magnetic, gravimetric or sieve process each homogeneous target populations with the same target receptor/acceptor specificity separated and isolated.

Another aspect of the invention relates to the use of the solid carrier according to the invention, wherein the solid carrier may have any geometrical shape, preferably microparticles. Particularly carrier materials of polystyrene (PS), polymethacrylate (PMA), Polyactide (PLA) or other plastics are preferred. Likewise preferred carrier materials are made of sepharoses, alginates or similar organic materials.

The present method is suitable for the separation of cells from body fluids with applications in biotechnology, medical research, diagnosis and treatment of diseases in particular.

Whereas in the state of art the sequential separation of cells with the same and different surface structures is well known, the process according to the invention allows for the first time a real simultaneous separation of cells and/or bioparticles using only one solid carrier having at least two capture molecules of different target specificity. The method can be used for the isolation/separation of cells with large numbers of cells, little effort and little work material in a short time and stress less for the cells. The method allows by means of simple physical separation methods the simultaneous isolation/separation of sub-populations with overlapping surface properties. The method allows the direct use in a reactor in the whole blood of a subject and is therefore also for therapeutically/diagnostically extracorporeal use.

The following application example describes the methodological implementation for individual applications. The expert can combine and modify arbitrarily according to the applications and the target goal.

### Embodiment 1

Combination of Capture Neutralization, by Replacement of the Capture-Target-Complex from the Trap Particles, with Non Neutralizable Capture Molecules

At capture particles (for example polystyrene particles with 30 microns diameter), anti-CD8 antibody are covalently bonded through carboxyl groups (NHS/EDS) and anti-CD3 antibody is bound via a linker Destiobiotin. The capture particles are add in whole blood and incubated for 15 min in a rolling way. During this time CD3-positive and CD8-positive cells will bind to the particles. These are isolated by means of an appropriate sieve (e.g. pluriStrainer) from the whole blood and washed. Afterwards the Destiobiotin coupled anti-CD3 antibody linker is displaced from the capture particles by the addition of 12 mM solution of biotin. On particles remain all CD8-positive cells, including the CD3/CD8-positive cells. Detached cells are CD3+ and CD8−.

### Embodiment 2

Combination of Capture Neutralization, by Disintegration of the Capture/Target Antibody/Antigen Complex, with Non-Neutralizable Capture Molecules

At capture particles (for example polystyrene particles with 30 microns diameter), anti-CD14 antibodies are covalently bound through carboxyl groups (NHS/EDS), and anti-CD4 antibody is coupled via a linker. The capture particles are add in whole blood and incubated for 15 min in a rolling way. During this time CD14-positive and CD4-positive cells bind to the particles. These are isolated by means of an appropriate sieve (e.g. pluriStrainer) from the whole blood and washed. Then to the anti-CD4 antibody a peptide is added with a higher affinity that displaces the antibody from the receptor on the cell. On particles remain all CD14-positive cells, including the CD4/CD14-positive cells. Detached cells are CD4+ and CD14− (FIG. 1).

### Embodiment 3

Combination of Capture Neutralization, by Disintegration and Detachment, with Non Neutralizable Capture Molecules

At capture particles (for example polystyrene particles with 30 microns diameter), anti-CD14 antibodies are covalently bound through carboxyl groups (NHS/EDS), and anti-CD4 antibody with a DNA linker is coupled. The capture particles are add in whole blood and incubated for 15 min in a rolling way. During this time CD14 -positive and CD4-positive cells bind to the particles. These are isolated by means of an appropriate sieve (e.g. pluriStrainer) from the whole blood and washed. Thereafter, the DNA linker coupled anti-CD4 antibodies are detached by the addition of a DNase solution and is isolated from the capture particles. On particles remain all CD14-positive cells, including the CD4/CD14-positive cells. Detached cells are CD4+ and CD14− (FIG. 2).

### Embodiment 4

Combination of Capture Neutralization by Disintegration and Separation of the Capture Target Complex from the Catcher Particle

At catcher particles (e.g. polystyrene particles 30 microns in diameter) anti-CD3 antibody is coupled via a linker Destiobiotin and anti-CD4 antibody is coupled via a DNA-linker. The capture particles are add in whole blood and incubated for 15 min in a rolling way. During this time CD3-positive and CD4-positive cells bind to the particles. These are isolated by means of an appropriate sieve (e.g. pluriStrainer) from the whole blood and washed. Then first the Destiobiotin linker-coupled anti-CD3-antibodies are displaced by the addition of 12 mM biotin solution from the catcher particle. On particles remain all CD4-positive cells, including the CD4/CD3-positive cells. Detached cells are CD3+ and CD4−. Thereafter, the DNA linker coupled anti-CD4+ antibody are cut by the addition of a DNase solution by scavenging particles. Detached cells are CD3+ and CD4+.

### Embodiment 5

Combination of Capture Neutralization by Disintegration and Separation of the Capture Target Complex from the Catcher Particles and the Catcher Particle with Non Neutralizable Capture Molecules

At capture particles (for example polystyrene particles with 30 microns diameter), anti-CD14 antibodies are covalently bound through carboxyl groups (NHS/EDS) and anti-CD3 antibody with a Destiobiotin linker is coupled, and anti-CD4 antibody with a DNAlinker is coupled. The capture particles are add to whole blood and incubated for 15 min in a rolling way. During this time CD3-positive and CD4 -positive cells and CD14-positive cells bind to the particles. These are isolated by means of an appropriate sieve (e.g. pluriStrainer) from the whole blood and washed. Then first the Destiobiotin linker -coupled anti-CD3-antibodies are displaced by the addition of 12 mM biotin solution from the catcher particle. On particles remain all CD4- and CD14-positive cells, including the CD4/CD3- and CD4/CD14-positive cells. Detached cells are CD3+ and CD4− and CD14−. Thereafter, the DNA linker coupled anti-CD4 antibodies by the addition of a DNase solution is isolated from the capture particles. Detached cells are CD3+/−and CD4+ and CD14−. On particles remain all CD14-positive cells, including the CD4/CD14-positive cells.

### DESCRIPTION OF THE FIGURES

FIG. 1a: Isolation of CD4-positive cells from whole blood with detaching by Displacement without combination with covalently bound CD14.

FIG. 1b: FIG. 2 Isolation of CD4-positive cells from whole blood with detaching by displacement with the combination with covalently bound CD14

FIG. 2a: Isolation of CD4-positive cells from whole blood with detaching by DNAse-digestion of the DNA linker without combination with covalently bound CD14.

FIG. 2b: Isolation of CD4-positive cells from whole blood with detaching by

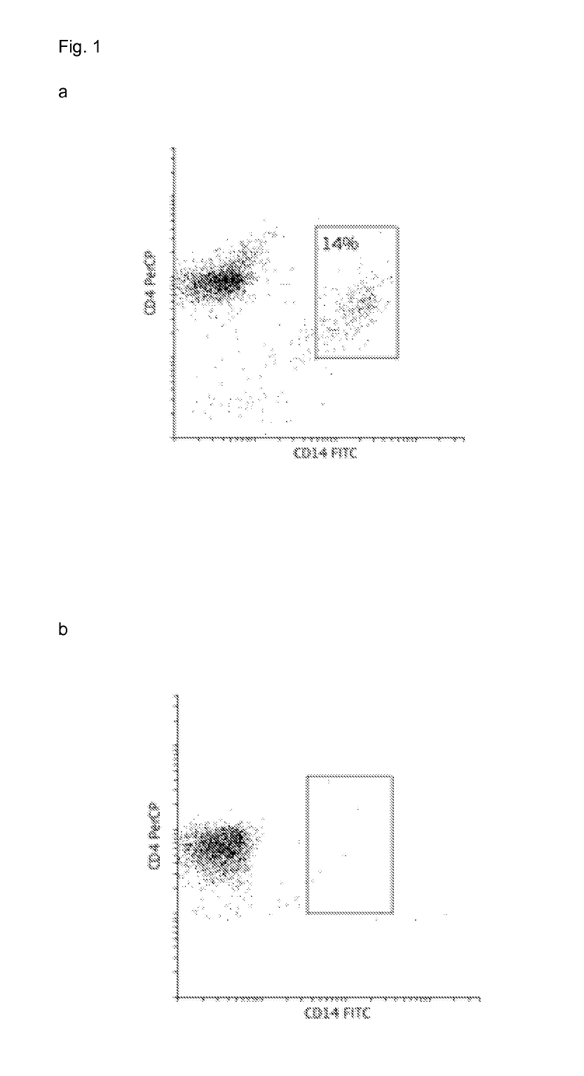

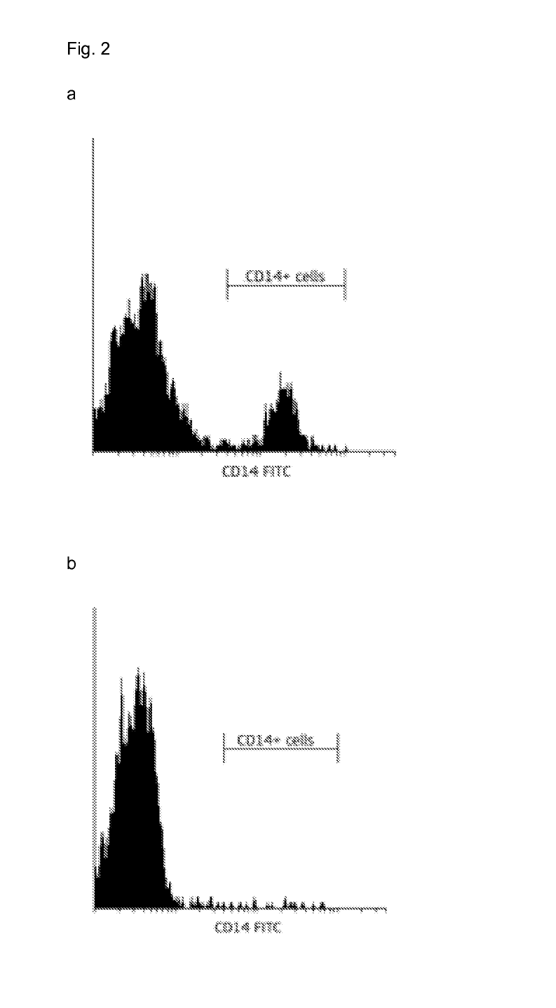

DNAse-digestion of the DNA linker with the combination with covalently bound CD14.

1. Method for separating and isolating various cells or bioparticles by means of a solid carrier, wherein on the solid carrier on his surface are coupled at least two capture molecules of different target specificity by known methods, and from which at least one capture molecule by known methods can be treated that the direct bridge connection between the capture molecule and target particles, or between the capture molecule and the carrier is dissolved, brought into contact with a liquid containing the target particle and then the carrier-capture molecule-target complexes are isolated first by known techniques and then the target particles are removed sequentially via cleavage of the respective bridge connection.

2. A method according to claim 1, wherein antibodies are used as capture molecules that are bound adsorptive or covalently or non-covalently to the carrier surface.

3. A method according to claim 1, wherein the capture molecules are provided directly or via a spacer/bridge molecules with predetermined properties for a chemical or enzymatic or physical separation of spacer and target.

4. A method according to claim 1, wherein the capture molecules can be made in addition magnetizable and/or fluorescent.

5. A method according to claim 1, wherein the bridge connection between the carrier-capture molecule complex and the target particles is resolved by a separation of the capture molecule from the target particles or from the carrier or by resolution of the binding between the capture molecule and target particles.

6. A method according to claim 1, wherein the separation of the capture molecule from the target particles or the solid carrier by the action of enzymes or hydrogen bond reducing substances takes place.

7. A method according to claim 1, wherein the dissolution of the bond between the capture molecule and target particles by a displacement reaction by receptor- or acceptor-mimicking substances with higher specific binding strength than that between the capture molecule receptor and target particles acceptor occurs.

8. A method according to claim 1, wherein for each desired specificity of the capture molecule on the solid carrier, preferably a different procedure of dissolution of the direct bridges connection between the carrier link-capture molecule complex and the target particles is provided.

9. A method according to claim 1, wherein an unlimited number of different capture molecule specificities are bound to the surface of the solid carrier, limited only by steric hindrance or by the number of target particles or the sum of the available methods for resolution of direct bridges connection between the carrier-capture molecule complex and target particles.

10. A method according to claim 9, wherein the dissolution of the bridges connection between the solid carrier-capture molecule complex and target particles, for example, reducing agents such as β-mercaptoethanol, dithiothreitol, dithioerythritol, tris (hydroxypropyl) phosphine, tris (2-carboxyethyl)phosphine, enzymes, depending on the existing interface within or in the vicinity of the spacer, and substances with a higher avidity than those existing between the capture molecule and the receptor, such as Target particle acceptor displacing Destiobiotin by biotin are used.

11. A method according to claim 1, wherein the use of the solid carrier separated target particles with both matching and also not matching capture molecule-target specificities are separated and isolated by gradual dissolution of the bridge connection between the carrier-capture molecule complex and target particles followed by a subsequent separation by means of known magnetic, gravimetric or sieve process in each homogeneous target populations with the same target receptor/acceptor specificity.

12. A method according to claim 1, wherein the solid carrier can have any geometrical shape, preferably microparticles.

13. (canceled)
